(19) United States
(12) Patent Application Publication
(10) Pub. No.: US 2014/0341176 A1
(43) Pub. Date: Nov. 20, 2014

(54) Method and Related Communication Device for Device Discovery in Device to Device Communication

(71) Applicant: HTC CORPORATION, Taoyuan County (TW)

(72) Inventor: Feng-Seng Chu, Taoyuan County (TW)

(73) Assignee: HTC CORPORATION, Taoyuan County (TW)

(21) Appl. No.: 14/279,291

(22) Filed: May 15, 2014

Related U.S. Application Data
(60) Provisional application No. 61/824,357, filed on May 16, 2013.

(51) Int. Cl. H04W 8/00; H04W 72/00; H04J 13/00

(52) U.S. Cl. CPC H04W 8/005; H04J 13/0062; H04W 72/005
USPC 370/330; 370/328

(57) ABSTRACT

A method of device discovery in device to device (D2D) communication between a first user equipment (UE) and a second UE includes the first UE broadcasting a first signal including a first Zadoff-Chu (ZC) sequence; and the second UE receiving the first signal directly from the first UE and determining whether to respond to the first UE with a second signal, where the second signal is generated by the second UE based on the first ZC sequence.

### CROSS REFERENCE TO RELATED APPLICATIONS

This application claims the benefit of U.S. Provisional Application No. 61/824,357, filed on May 16, 2013 and entitled “Method and Apparatus for device discovery in D2D communication”, the contents of which are incorporated herein in their entirety.

### BACKGROUND OF THE INVENTION

1. Field of the Invention

The present invention relates to a method utilized in a wireless communication and communication device thereof, and more particularly, to a method for device discovery in device to device (D2D) communication and communication device thereof.

2. Description of the Prior Art

A long-term evolution (LTE) system supporting the 3GPP Rel-8 standard and/or the 3GPP Rel-9 standard are developed by the 3rd Generation Partnership Project (3GPP) as a successor of a universal mobile telecommunication system (UMTS) for further enhancing performance of the UMTS to satisfy increasing needs of users. The LTE system includes a new radio interface and a new radio network architecture that provides high data rate, low latency, packet optimization, and improved system capacity and coverage. In the LTE system, a radio access network known as an evolved universal terrestrial radio access network (E-UTRAN) includes multiple evolved Node-Bs (eNEs) for communicating with multiple user equipments (UEs), and communicating with a core network including a mobility management entity (MME), a serving gateway, etc., for Non-Access Stratum (NAS) control.

An LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint transmission/reception (CoMP), uplink (UL) multiple-input multiple-output (MIMO), etc. For a UE and an eNB to communicate with each other in the LTE-A system, the UE and the eNB must support standards developed for the LTE-A system, such as the 3GPP Rel-10 standard or later versions.

Starting from 3GPP Rel-12, a feature is included to allow UEs to communicate with each other directly, which is referred to as device to device (D2D) communication or Proximity-based Services (ProSe) communication. The D2D communication finds its applications on areas including Public Safety and non-Public-Safety services that would be of interest to operators and users. Proximity-based applications and services represent an emerging social-technological trend. The introduction of the device to device communication capability in LTE would allow the 3GPP industry to serve this developing market, and will, at the same time, serve the urgent needs of several Public Safety communities that are jointly committed to LTE.

However, in some situations, one or more UEs may be out of network coverage so that the UEs cannot perform the D2D communication even if they are in close proximity to each other. The capability of directly communicating with each other without the need of network control and management is very important, especially for public safety services because certain remote areas or a basement of a building may be out of network coverage, or the network elements may stop operating under emergency situations such as an earthquake and a power failure.

Thus, how to discover a neighboring device by a UE itself is an important topic to be addressed and discussed in the art.

### SUMMARY OF THE INVENTION

An objective of the present invention is to provide a method and related communication device for device discovery in D2D communication so that one UE can be discovered by another UE no matter whether any of the UEs is in or out of network coverage.

The present invention discloses a method of device discovery in device to device (D2D) communication between a first user equipment (UE) and a second UE. The method includes the first UE broadcasting a first signal including a first Zadoff-Chu (ZC) sequence; and the second UE receiving the first signal directly from the first UE and responding to the first UE with a second signal; wherein the second signal is generated by the second UE based on the first ZC sequence.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

### DETAILED DESCRIPTION

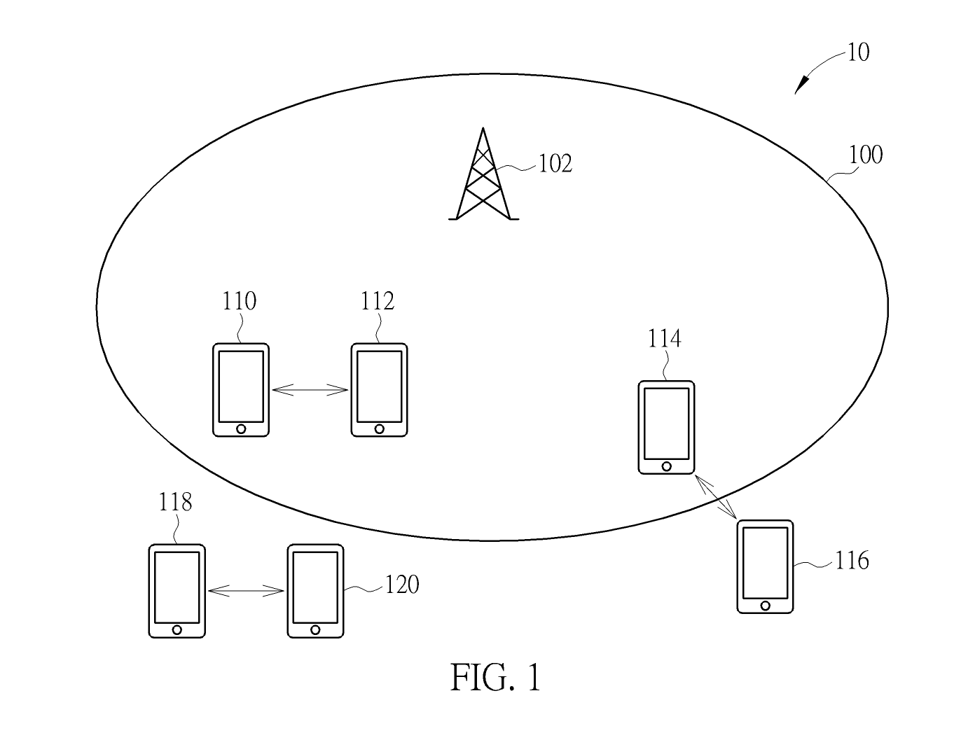

Please refer to FIG. 1, which is a schematic diagram of a wireless communication system 10 according to an example of the present invention. A wireless communication system which is applicable to the present invention may include at least one base station and at least two user equipments (UEs). For the sake of simplicity of description, FIG. 1 only shows a base station 102 in the wireless communication system 10. Practically, the wireless communication system may include a plurality of base stations and other network elements to provide network coverage 100 with network control and management functionalities. The network can be a universal terrestrial radio access network (UTRAN), and the base stations may be Node-Bs (NBs) in a universal mobile telecommunications system (UMTS). Alternatively, the network can be an evolved UTRAN (E-UTRAN), and the base stations may be evolved NBs (eNBs) and/or relays in a long term evolution (LTE) system or a LTE-Advanced (LTE-A) system.

Furthermore, the network can also include both the UTRAN/E-UTRAN and a core network, wherein the core network includes network entities such as Mobility Management Entity (MME), Serving Gateway (S-GW), Packet Data Network (PDN) Gateway (P-GW), Self-Organizing Networks (SON) server and/or Radio Network Controller (RNC), etc. In other words, after the network receives information transmitted by a UE, the information may be processed only by the UTRAN/E-UTRAN and decisions corresponding to the information are made at the UTRAN/E-UTRAN. Alternatively, the UTRAN/E-UTRAN may forward the information to the core network, and the decisions corresponding to the information are made at the core network after the core network processes the information. Besides, the information can be processed by both the UTRAN/E-UTRAN and the core network, and the decisions are made after coordination and/or cooperation are performed by the UTRAN/E-UTRAN and the core network.

The UEs can be portable communication devices for performing speech and data communication through the network such as the UMTS, the LTE system or the LTE-A system. Besides, the network and one of the UEs can be seen as a transmitter or a receiver according to transmission direction, e.g., for an uplink (UL), the communication device is the transmitter and the network is the receiver, and for a downlink (DL), the network is the transmitter and the communication device is the receiver.

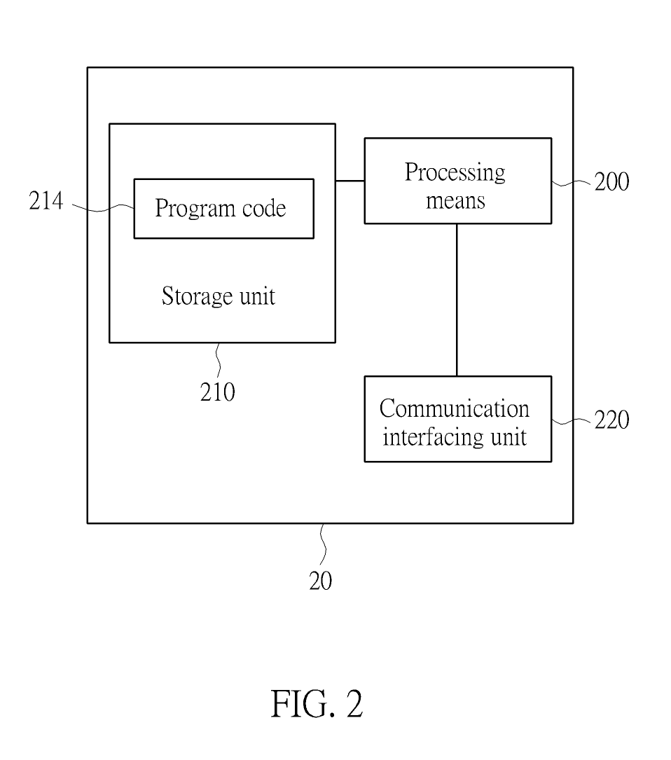

Please refer to FIG. 2, which is a schematic diagram of a communication device 20 according to an example of the present invention. The communication device 20 may be any one of the UEs 110, 112, 114, 116, 118, and 120 shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that can store a program code 214, accessed and executed by the processing means 200. Examples of the storage unit 210 include but are not limited to read-only memory (ROM), flash memory, random-access memory (RAM), CD-ROM/DVD-ROM, magnetic tape, hard disk and optical data storage device. The communication interfacing unit 220 is preferably a transceiver and is used to transmit and receive signals (e.g., messages or packets) according to processing results of the processing means 200.

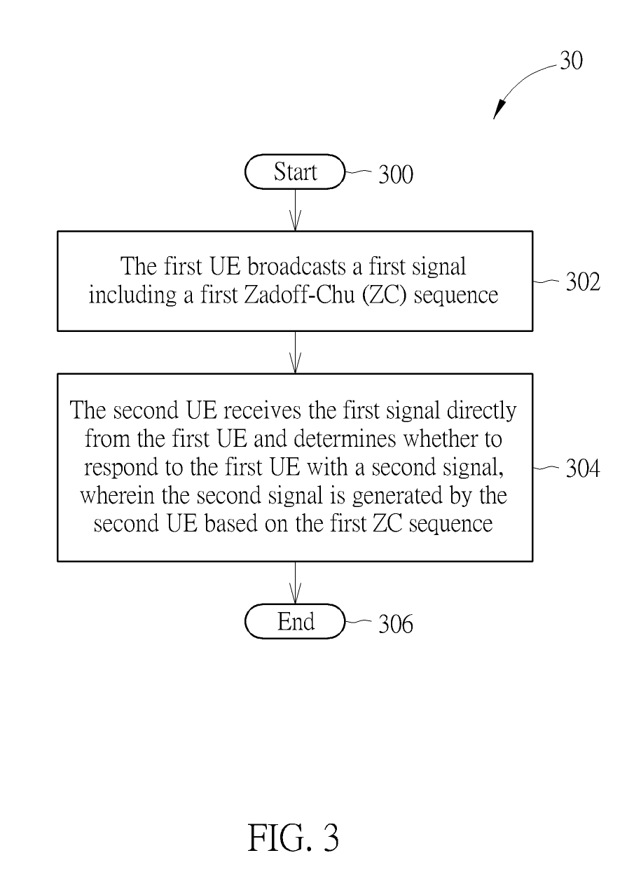

Please refer to FIG. 3, which is a flowchart of a process 30 according to an example of the present invention. The process 30 is utilized for a set of UEs (i.e. a first UE and a second UE) in which one of the UEs intends to discover or be discovered by the other UE without the need of network control and management. The process 30 may be used for the device discovery procedure in direct communications, such as device-to-device (D2D) communications or ProSe communications of direct data path type (which is called ProSe communication in short), but is not limited herein. The set of UEs may be the UEs 110 and 112, the UEs 114 and 116, or the UEs 118 and 120 in the wireless communication system 10 shown in FIG. 1. Each UE in the set of UEs may be realized by the communication device 20, in which the program code 214 instructs the processing means 200 to execute the corresponding steps of the process 30. Two communication devices 20 take the actions together to perform the process 30 as follows:

Step 300: Start.

Step 302: The first UE broadcasts a first signal including a first Zadoff-Chu (ZC) sequence.

Step 304: The second UE receives the first signal directly from the first UE and determines whether to respond to the first UE with a second signal, wherein the second signal is generated by the second UE based on the first ZC sequence.

Step 306: End.

According to the process 30, the first UE sends the first signal which includes the first ZC sequence. The second UE may be operated to monitor the first signal and obtain information such as the timing of the first UE from the first ZC sequence after receiving the first signal. Then, the second UE may determine whether it needs to respond to the first UE, and generate a determination result accordingly. If the determination result suggests that the second UE needs to respond to the first UE, the second UE may send the second signal including a second ZC sequence. The second signal may be correlated with the first ZC sequence included in the first signal. For example, a root and/or a cyclic shift of the second ZC sequence may be determined based on a root and/or a cyclic shift of the first ZC sequence included in the received first signal. As a result, the first UE may recognize that the second signal is a response for the first signal for device discovery. Therefore, a UE can discover or be discovered by the other UE even if any one of them is out of network coverage, and the time synchronization between the UEs may be built during the device discovery procedure if direct communication is needed.

The process 30 may be applied for a UE trying to be discovered by other UEs. This application is especially useful in situations such as asking for help or rescue in an emergency event. In this case, the first UE is the UE which is trying to be discovered, and the first signal may be a discovery signal to let other UEs know the first UE's location. The process 30 may also be applied for a UE trying to find other UEs initiatively. In this case, the first UE is the UE which is trying to find other UEs initiatively, and the first signal may be an inspiring signal which is sent for requesting a response for other UEs.

The process 30 is an example of the present invention, and those skilled in the art should readily make combinations, modifications and/or alterations on the abovementioned description and examples. For example, the first ZC sequence may be generated based on the definition in 3GPP Rel. 8-11. In another example, a root of the first ZC sequence may be different from the roots defined in 3GPP Rel. 8-11 for physical random access channel (PRACH). Alternatively, there may be no cyclic shift imposed on the first ZC sequence included in the first signal.

In an example, a transmission power of the first signal may be configured according to the root of the first ZC sequence and/or the amount of cyclic shifts in a pre-defined set (i.e. a total number of pre-defined cyclic shifts). The first UE may broadcast the first signal two or more times, where a transmission power of the first signal or the root and/or the cyclic shift of the first ZC sequence may not be the same in each time of the first signal broadcasting. That is, for example, the transmission power of the first signal or the root and/or the cyclic shift of the first ZC sequence may be the same in the first time and the second time of the first signal broadcasting, but in the third time of the first signal broadcasting the transmission power of the first signal or the root and/or the cyclic shift of the first ZC sequence may be different than those in the first and the second time of the first signal broadcasting. Moreover, an interval sequence or a period may be inserted in between two consecutive first signals being sent multiple times by the first UE, wherein the interval sequence or a period may be selected from a pre-defined set. The first signals being sent multiple times may help the second UE to build up the time synchronization with the first UE.

If the first UE is out of network coverage, the time and frequency on which the first signal is delivered is determined by the first UE. For example, the first UE may select the center 6 resource blocks (RBs) in several subframes as the time and frequency resources to broadcast the first signal. On the other hand, if the first UE is in network coverage, the time and frequency on which the first signal is delivered may be determined by the first UE and/or the network. In an example, the time and frequency resource for sending the first signal may be the same as the time and frequency resource for sending random access preambles on PRACH. In another example, the time and frequency resource for sending the first signal may be different than the time and frequency resource for sending random access preambles on PRACH.

The second UE determines whether it needs to respond to the first UE according to a receiving power of the first signal, a purpose of the first signal, and/or the first ZC sequence. For example, the second UE may find that first signal is sent because the first UE needs to broadcast its location but does not need to establish a connection. In such a condition, the second UE may determine that it does not need to respond to the first UE with any signal.

When the second UE determines to respond to the first UE, the second UE responds with the second signal including the second ZC sequence which may be generated based on the definition in 3GPP Rel. 8-11. As such, the first UE may obtain information such as the timing of the second UE from the second ZC sequence after receiving the second signal.

The root of the second ZC sequence may be the same as the root of the first ZC sequence, but the cyclic shift of the second ZC sequence may be different than the cyclic shift of the first ZC sequence. In an example, the cyclic shift imposed on the second ZC sequence may be selected according to an interval sequence of the received first signal. Alternatively, there may be no cyclic shift imposed on the second ZC sequence. Moreover, a transmission power of the second signal may be configured according to the root, cyclic shift of the first ZC sequence, and/or a receiving power of the first signal.

In addition, the second signal may carry some information related to the second UE. The second UE related information may include a Radio Network Temporary Identifier (RNTI), a terminal identity, a timing advance, and/or response resource (i.e. the time and frequency resource on which the second UE sends signals for response) of the second UE. The RNTI and the terminal identity of the second UE may be used for contention resolution and/or the following data processing. The timing advance of the second UE may be used for synchronization buildup.

If the second UE is out of network coverage, the time and frequency on which the second signal is delivered is determined by the second UE. For example, the second UE may select the center 6 resource blocks (RBs) in several subframes as the time and frequency resources to respond to the first UE with the second signal. On the other hand, if the second UE is in network coverage, the time and frequency on which the second signal is delivered may be determined by the second UE and/or the network. In an example, the time and frequency resource for sending the second signal may be the same as the time and frequency resource for sending random access preambles on PRACH. In another example, the time and frequency resource for sending the second signal may be different than the time and frequency resource for sending random access preambles on PRACH.

Furthermore, after receiving the second signal, the first UE understands the existence and the timing of the second UE. If further communication is required, the first UE may reply to the second UE with a third signal. The third signal may carry some information related to the first UE. The first UE related information may include an RNTI, a terminal identity, a timing advance, and/or response resource (i.e. the time and frequency resource on which the first UE sends signals for response or reply) of the first UE. The RNTI and the terminal identity of the first UE may be used for contention resolution and/or the following data processing. The timing advance of the first UE may be used for synchronization buildup.

The present invention may apply to any set of UEs which intend to have a D2D communication with each other, such as the UEs 110 and 112 which are both in the network coverage 100, the UEs 114 and 116 in which only one of them is in the network coverage 100, and the UEs 118 and 120 which are both out of the network coverage 100 shown in FIG. 1.

The abovementioned process 30 including suggested steps, examples, alterations, and modifications may be realized by means that could be hardware, firmware, software, or electronic system. Examples of hardware may include analog, digital and mixed circuits known as microcircuit, microchip, or silicon chip. Examples of the electronic system may include system on chip (SOC), system in package (SiP), and computer on module (COM).

In conclusion, the present invention provides a method of device discovery of UEs without the need of network control and management. The UE which intends to discover or be discovered by other UEs may broadcast the first signal including a ZC sequence and wait for response. The UE receiving the first signal may respond with the second signal which is generated based on the first signal. Therefore, the UEs can recognize each other, and may also buildup the time synchronization for further communications such as D2D communication.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of device discovery in device to device (D2D) communication between a first user equipment (UE) and a second UE, the method comprising:
the first UE broadcasting a first signal including a first Zadoff-Chu (ZC) sequence; and
the second UE receiving the first signal directly from the first UE and determining whether to respond to the first UE with a second signal;
wherein the second signal is generated by the second UE based on the first ZC sequence.

2. The method of claim 1, wherein a transmission power of the first signal is configured according to a root of the first ZC sequence and/or the amount of cyclic shifts in a pre-defined set.

3. The method of claim 1, wherein the first UE broadcasts the first signal multiple times, where a transmission power of the first signal or a root and/or a cyclic shift of the first ZC sequence is not the same in each time.

4. The method of claim 3, wherein the first UE broadcasts the first signal multiple times with an interval sequence or a period inserted in between two consecutive first signals being sent multiple times by the first UE, wherein the interval sequence or a period is selected from a pre-defined set.

5. The method of claim 1, further comprising:
the first UE replying the second UE with a third signal including a Radio Network Temporary Identifier (RNTI), a terminal identity, a timing advance, and/or response resource after receiving the second signal.

6. The method of claim 1, wherein the time and frequency on which the first signal is broadcast is determined by the first UE if the first UE is out of network coverage, and the time and frequency on which the first signal is broadcast is determined by the first UE and/or a network if the first UE is in network coverage.

7. The method of claim 1, wherein the step of the second UE receiving the first signal directly from the first UE and determining whether to respond to the first UE with the second signal comprises:
the second UE determining whether the second UE needs to respond to the first UE according to a receiving power of the first signal, a purpose of the first signal, and/or the first ZC sequence included in the first signal, and generating a determination result; and
the second UE responding to the first UE with the second signal according to the determination result.

8. The method of claim 1, wherein the second signal includes a second ZC sequence.

9. The method of claim 8, wherein a root and/or a cyclic shift of the second ZC sequence is correlated with a root and/or a cyclic shift of the first ZC sequence.

10. The method of claim 8, wherein a cyclic shift imposed on the second ZC sequence is selected according to an interval sequence of the received first signal.

11. The method of claim 1, wherein a transmission power of the second signal is configured according to the first ZC sequence.

12. The method of claim 1, wherein the second signal carries related information of the second UE, wherein the related information includes a Radio Network Temporary Identifier (RNTI), a terminal identity, a timing advance, and/or response resource.

13. The method of claim 1, wherein the time and frequency on which the second signal is sent for response is determined by the second UE if the second UE is out of network coverage, and the time and frequency on which the second signal is sent for response is determined by the second UE and/or a network if the second UE is in network coverage.
